(19) United States
(12) Patent Application Publication
(10) Pub. No.: US 2018/0354104 A1
(43) Pub. Date: Dec. 13, 2018

(54) Tool Adapter For Power Tool

(71) Applicant: Hong Ann Tool Industries Co., Ltd., Taichung City (TW)

(72) Inventor: Cheng-Wei Su, Taichung City (TW)

(21) Appl. No.: 15/962,046

(22) Filed: Apr. 25, 2018

(30) Foreign Application Priority Data
Jun. 7, 2017 (TW) 106118867

(51) Int. Cl. B25B 23/00

(52) U.S. Cl. CPC B25B 23/0035; B25B 21/00

(57) ABSTRACT

A tool adapter includes a main body having a first engaging end adapted to engage with the power tool and a second engaging end adapted to receive the driving head respectively and a device adapted to retain the driving head. The second engaging end includes a receptacle adapted to receive the driving head. The main body includes a hole communicated with the receptacle. The hole extends radially from the receptacle to an outer periphery of the main body. The outer periphery of the main body includes a first threaded portion. The device includes a retaining member disposed in the hole and a sleeve mounted on the outer periphery of the main body and threadedly engaged with the first threaded portion. An inner periphery of the sleeve includes a second threaded portion engaged with the first threaded portion and an interacting portion adapted to interact with the retaining member.

### BACKGROUND OF THE INVENTION cl 1. Field of the Invention

The present invention relates to a tool adapter and, particularly, to a tool adapter for coupling a driving head to a power tool.

### 2. Description of the Related Art

TW Pat. No. M425028 shows a quick release bit holder. The quick release bit holder includes a shank, a sleeve, a spring, and a detent ball. The shank has a hole for receiving a bit and a hole for receiving the detent ball. The sleeve is movably mounted on the shank and movable between a first position to push the detent ball to exert a radial retaining force on the bit and a second position to permit the detent ball to move radially outward and to disengage from the bit. The spring is retained between the shank and the sleeve and is compressed when the sleeve disengages from the bit. The sleeve can be easily moved from the first position to the second position, but shakes when the quick release bit holder is driven by a power tool. Hence, the bit can disengage from the quick release bit holder.

The present invention is, therefore, intended to obviate or at least alleviate the problems encountered in the prior art.

### SUMMARY OF THE INVENTION

According to the present invention, a tool adapter for a power tool includes a main body having a first engaging end adapted to engage with the power tool and a second engaging end adapted to receive the driving head respectively and a device adapted to retain the driving head. The second engaging end includes a receptacle adapted to receive the driving head. The receptacle extends along a longitudinal axis of the main body. The main body includes a hole communicated with the receptacle. The hole extends radially from the receptacle to an outer periphery of the main body. The outer periphery of the main body includes a first threaded portion. The device includes a retaining member disposed in the hole and a sleeve mounted on the outer periphery of the main body and threadedly engaged with the first threaded portion. An inner periphery of the sleeve includes a second threaded portion engaged with the first threaded portion and an interacting portion adapted to interact with the retaining member.

When the driving head is retained and prevented from moving out of the receptacle, the sleeve is threadedly moved to a first position, a first section of the interacting portion corresponds to the retaining member, and the retaining member is fixed and protrudes in the receptacle to tightly push the driving head. When the driving head is not retained and can move out of the receptacle, the sleeve is threadedly moved to a second position, a first section of the interacting portion corresponds to the retaining member, and the retaining member is the receptacle.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an objective of the present invention to provide a tool adapter for coupling a driving head to a power tool.

It is another objective of the present invention to prevent the tool adapter accidentally disengages the driving head when being driven by the power tool.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view showing a tool adapter in accordance with the present invention and a driving head engaged with the tool adapter;

FIG. 2 is an exploded perspective view of the tool adapter;

FIG. 3 is a perspective view showing the tool adapter and the driving head disengaged from each other;

FIG. 4 is a cross-sectional view showing the tool adapter and the driving head disengaged from each other;

FIG. 5 is a cross-sectional view showing the tool adapter and the driving head engaged with each other;

FIG. 6 is a cross-sectional view taken along line 6-6 of FIG. 5.

### DETAILED DESCRIPTION OF THE INVENTION

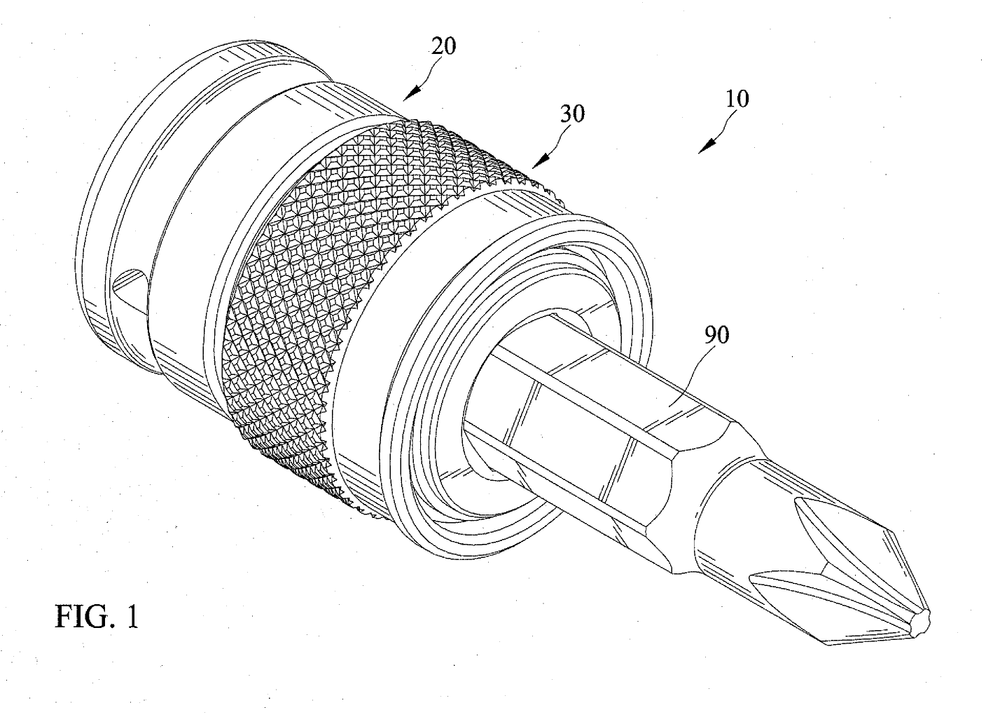

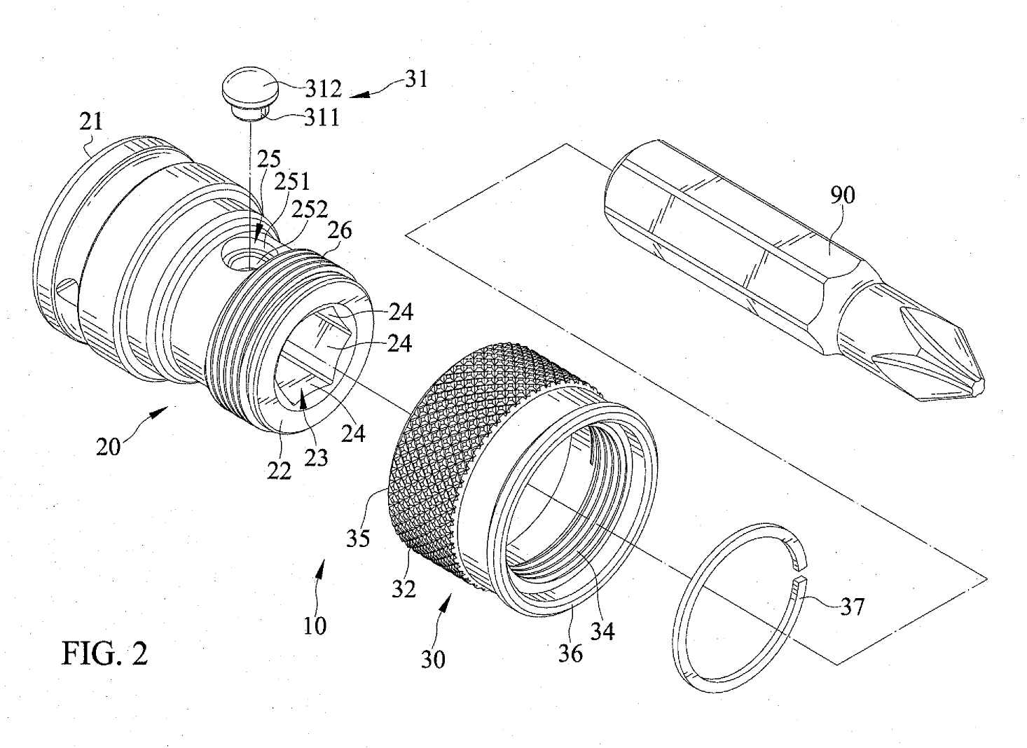

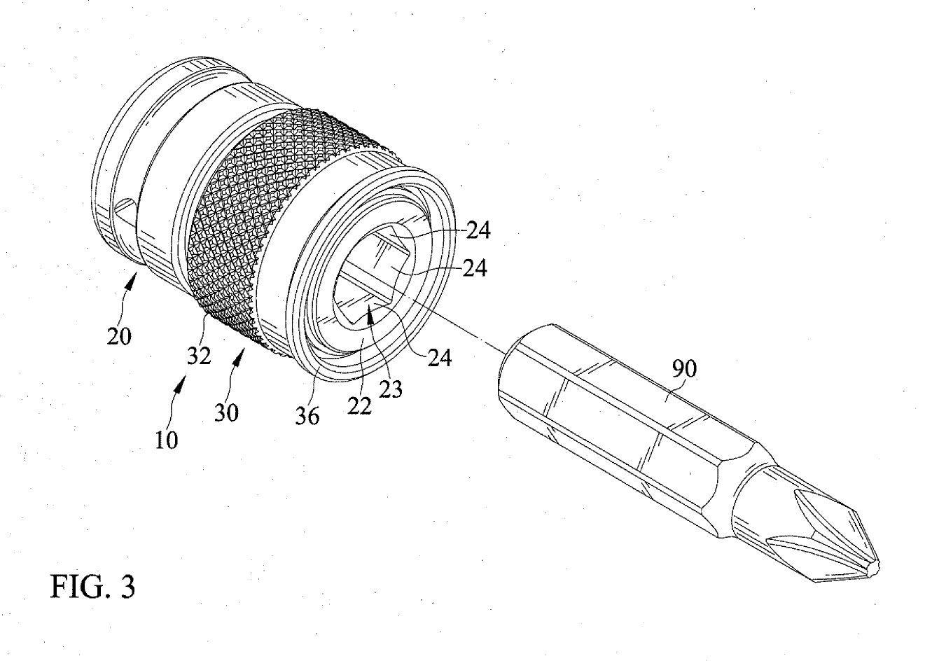

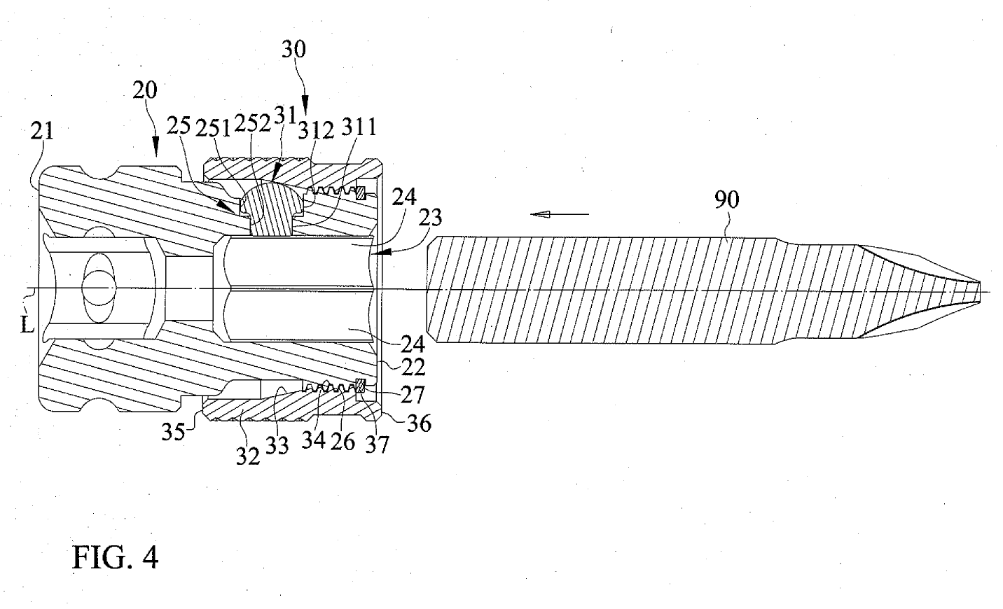

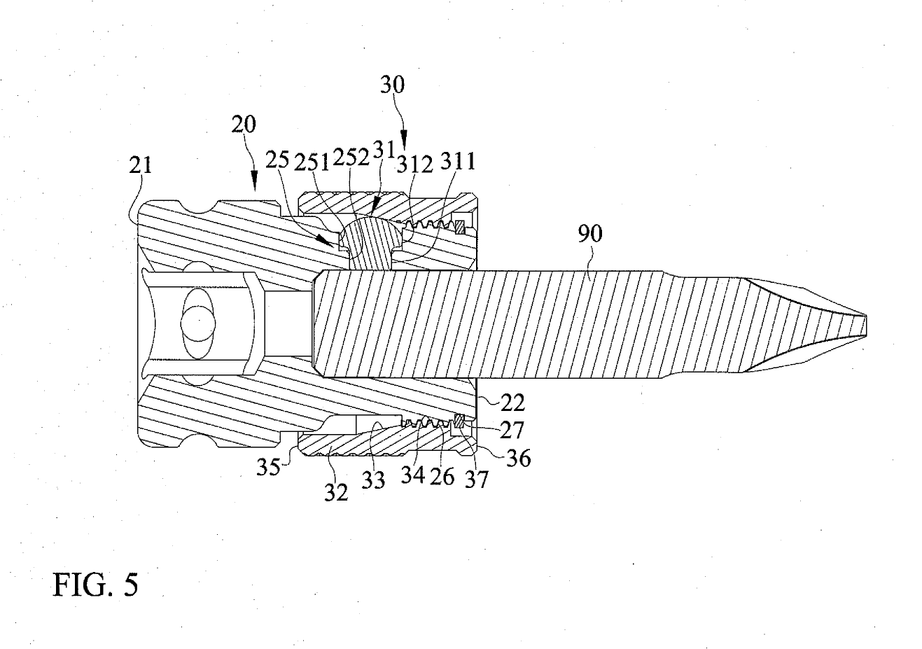

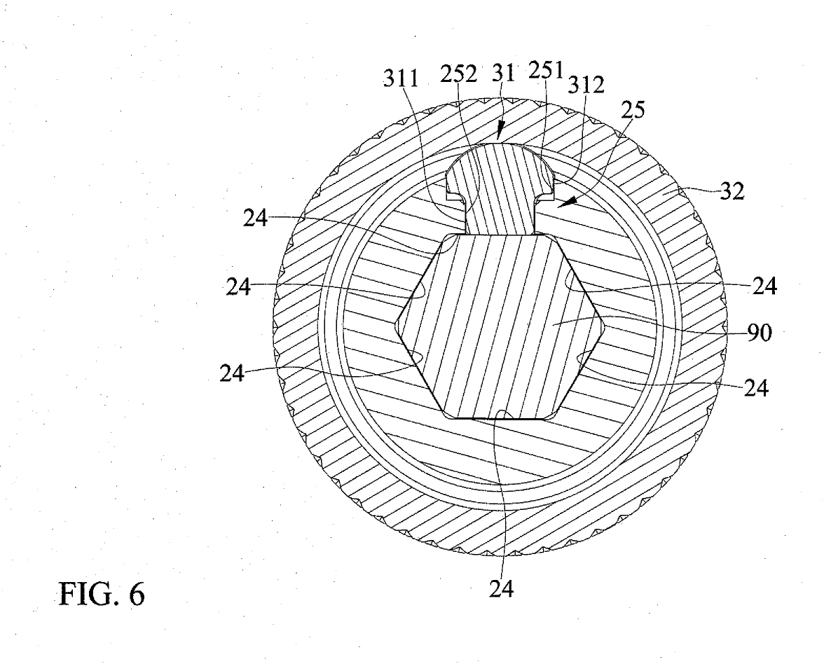

FIGS. 1 through 6 show a tool adapter 10 in accordance with the present invention. The tool adapter 10 is adapted to couple a driving head 90 to a power tool.

The tool adapter 10 includes a main body 20 having a first engaging end 21 adapted to engage with the power tool and a second engaging end 22 adapted to receive the driving head 90 respectively. The second engaging end 22 includes a receptacle 23 adapted for receiving the driving head 90. The receptacle 23 extends along a longitudinal axis L of the main body 20. The receptacle 23 is a polygonal. In the embodiment, the cross section of the receptacle 23 is hexagonal. Thus, the receptacle 23 has six peripheral sides 24. The main body 20 includes a hole 25 communicated with the receptacle 23. The hole 25 is a countersink hole which includes a first hole portion 251 of a first diameter and a second hole portion 252 of a second diameter smaller than the first diameter. The hole 25 extends radially from the receptacle 23 to an outer periphery of the main body 20. The outer periphery of the main body 20 includes a first threaded portion 26.

The tool adapter 10 also includes a device 30 adapted to retain the driving head 90. The device 30 includes a retaining member 31 movably disposed in the hole 25. The device 30 also includes a sleeve 32 mounted on the outer periphery of the main body 20 and threadedly engaged with the first threaded portion 26. An inner periphery of the sleeve 32 includes a second threaded portion 34 engaged with the first threaded portion 26 and an interacting portion 33 adapted to interact with the retaining member 31. The retaining member 31 has a shank portion 311 and an enlarged head portion 312 configured to interact with the interacting portion 33. The enlarged head portion 312 is disposed in the first hole portion 251 and the shank portion 311 is disposed in the second hole portion 252 respectively. The sleeve 32 has a first distal end 35 and a distal second end 36 and the inner periphery of the sleeve 32 extend from the first distal end 35 to the second distal end 36. The interacting portion 33 is inclined. The interacting portion 33 is convergent in a direction from the first distal end 35 to the second distal end 36. In addition, in order to facilitate movement of the retaining member 31, the enlarged head portion 312 is hemispherical.

Furthermore, the tool adapter 10 includes a stop 37 preventing disengagement of the sleeve 32 from the main body 20. The outer periphery of the main body 20 includes a groove 27 configured to receive the stop 37. The groove 27 extends annularly on the outer periphery of the main body 20. The stop 37 is annular shaped. The stop 37 is resilient. The groove 27 is cut on the first threaded portion 26. The groove 27 is disposed between two threads of the first threaded portion 26. The inner periphery of the sleeve 32 includes an edge against which the stop 37 selectively abuts. The sleeve 32 is prevented disengagement from the main body 20 when the stop 37 stops the sleeve 32 on the edge.

When the driving head 90 is retained and prevented from moving out of the receptacle 23, the sleeve 32 is threadedly moved to a first position, a first section of the interacting portion 33 corresponds to the retaining member 31, and the retaining member 31 is fixed and protrudes in the receptacle 23 to tightly push the driving head 90. When the driving head 90 is not retained and can move out of the receptacle 23, the sleeve 32 is threadedly moved to a second position, a first section of the interacting portion 33 corresponds to the retaining member 31, and the retaining member 31 is the receptacle 23.

In view of the forgoing, when the tool adapter 10 is rapidly driven by the power tool, the device 30 can retain the driving head 90 and prevent it from moving out of the receptacle 23 accidentally.

The foregoing is merely illustrative of the principles of this invention, and various modifications can be made by those skilled in the art without departing from the scope and spirit of the invention.

What is claimed is:

1. A tool adapter adapted to couple a driving head to a power tool, comprising:
a main body having a first engaging end adapted to engage with the power tool and a second engaging end adapted to receive the driving head respectively, wherein the second engaging end includes a receptacle adapted for receiving the driving head, wherein the receptacle extends along a longitudinal axis of the main body, wherein the main body includes a hole communicated with the receptacle, wherein the hole extends radially from the receptacle to an outer periphery of the main body, and wherein the outer periphery of the main body includes a first threaded portion; and
a device adapted to retain the driving head including a retaining member movably disposed in the hole and a sleeve mounted on the outer periphery of the main body and threadedly engaged with the first threaded portion, wherein an inner periphery of the sleeve includes a second threaded portion engaged with the first threaded portion and an interacting portion adapted to interact with the retaining member, wherein when the driving head is retained and prevented from moving out of the receptacle, the sleeve is threadedly moved to a first position, a first section of the interacting portion corresponds to the retaining member, and the retaining member is fixed and protrudes in the receptacle to tightly push the driving head, and wherein when the driving head is not retained and can move out of the receptacle, the sleeve is threadedly moved to a second position, a first section of the interacting portion corresponds to the retaining member, and the retaining member is the receptacle.

2. The tool adapter as claimed in claim 1, wherein the sleeve has a first distal end and a distal second end and the inner periphery of the sleeve extend from the first distal end to the second distal end, and wherein the interacting portion is inclined.

3. The tool adapter as claimed in claim 1 further comprising a stop configured to prevent the sleeve disengaging from the main body.

4. The tool adapter as claimed in claim 3, wherein the sleeve has a first distal end and a distal second end and the inner periphery of the sleeve extend from the first distal end to the second distal end, and wherein the interacting portion is inclined.

5. The tool adapter as claimed in claim 3, wherein the outer periphery of the main body includes a groove configured to receive the stop, wherein the groove extends annularly on the outer periphery of the main body, and wherein the stop is annular shaped.

6. The tool adapter as claimed in claim 5, wherein the inner periphery of the sleeve includes an edge against which the stop selectively abuts, and wherein the sleeve is prevented disengagement from the main body when the stop stops the sleeve on the edge.

7. The tool adapter as claimed in claim 6, wherein the second threaded portion is disposed between the interacting portion and the edge.

8. The tool adapter as claimed in claim 7, wherein the sleeve has a first distal end and a distal second end and the inner periphery of the sleeve extend from the first distal end to the second distal end, and wherein the interacting portion is inclined.

9. The tool adapter as claimed in claim 1, wherein the hole is a countersink hole which includes a first hole portion of a first diameter and a second hole portion of a second diameter smaller than the first diameter, wherein the retaining member has a shank portion and an enlarged head portion configured to interact with the interacting portion, and wherein the enlarged head portion is disposed in the first hole portion and the shank portion is disposed in the second hole portion respectively.

10. The tool adapter as claimed in claim 9, wherein the sleeve has a first distal end and a distal second end and the inner periphery of the sleeve extend from the first distal end to the second distal end, and wherein the interacting portion is inclined.

11. The tool adapter as claimed in claim 9 further comprising a stop configured to prevent the sleeve disengaging from the main body.

12. The tool adapter as claimed in claim 11, wherein the outer periphery of the main body includes a groove configured to receive the stop, wherein the groove extends annularly on the outer periphery of the main body, and wherein the stop is annular shaped.

13. The tool adapter as claimed in claim 12, wherein the inner periphery of the sleeve includes an edge against which the stop selectively abuts, and wherein the sleeve is prevented disengagement from the main body when the stop stops the sleeve on the edge.

14. The tool adapter as claimed in claim 13, wherein the second threaded portion is disposed between the interacting portion and the edge.

15. The tool adapter as claimed in claim 14, wherein the sleeve has a first distal end and a distal second end and the inner periphery of the sleeve extend from the first distal end to the second distal end, and wherein the interacting portion is inclined.
